(19) United States
(12) Patent Application Publication
(10) Pub. No.: US 2012/0030211 A1
(43) Pub. Date: Feb. 2, 2012

(54) MESSAGE PROCESSING METHOD AND SYSTEM

(75) Inventors: Keke Cai, Beijing (CN); Hong Lei Guo, Beijing (CN); Zong Su, Beijing (CN); Xian Wu, Beijing (CN); Li Zang, Beijing (CN)

(73) Assignee: International Business Machines Corporation, Armonk, NY (US)

(21) Appl. No.: 13/193,485

(22) Filed: Jul. 28, 2011

(30) Foreign Application Priority Data
Jul. 28, 2010 (CN) 201010243659.1

(51) Int. Cl. G06F 15/16; G06F 17/30

(52) U.S. Cl. 707/741; 709/206; 707/E17.002; 707/E17.005

(57) ABSTRACT

A message processing method and system. The message processing method includes: acquiring messages and position information of the messages; clustering the messages according to the position information of the message to obtain message clusters; extracting addresses in contents of the messages in the message cluster; and building classifiers of the addresses based on the contents of the messages in the same message cluster. By sufficiently utilizing the position information of the related message, etc., the system can conveniently provide the message users with related accurate address information and can provide useful information for management decision.

### CROSS-REFERENCE TO RELATED APPLICATIONS

This application claims priority under 35 U.S.C. §119 to Chinese Patent Application No. 201010243659.1 filed Jul. 29, 2010, the entire text of which is specifically incorporated by reference herein.

1. Technical Field

The present invention generally relates to message processing technical field, and more specifically, relates to a message processing method and system.

2. Description of the Related Art

With the development of the Internet, communication facilities, and civilian media, people are faced with more and more information. People need related technical means to analyze the information to provide more useful information for users. For example, the microblog which is popular nowadays or any other social network services like Twitter and Sina Microblog, which supports mobile terminals such as Twitter and Sina microblog. The basic data unit of Twitter is named a tweet which can be generated by a characterized in that a general user via either web or mobile terminals can send his/her short message to a Twitter server, and a reader user of the short message can remark on the short message by retweeting or replying it. Starting from the late 2009, a reader user can follow up short messages of other reader users. All the message users can receive or transmit Twitter messages through the Twitter website. There are more than 100,000,000 Twitter users all over the world, and Twitter still grows up at an incredible speed with 300,000 new users every day. Since 20% of the users log on the Twitter website though their mobile telephones, some tweets may include position information, e.g., GPS (Global Positioning System) coordinates. Due to the usage convenience and broad mobile supports, users tends to use micro blog to record what he is doing right now. As a result, the content of micro blog is quite time sensitive.

### SUMMARY

The present invention provides a message processing method and system.

According to an aspect of the invention, a message processing method is provided, comprising: acquiring messages and position information of the messages; clustering the messages according to the position information of the messages; extracting addresses in contents from the message clusters; and training classifiers for identifying different addresses based on the content of the messages in the same message cluster.

Preferably, the message processing method of the invention further comprises: receiving a message that does not contain an address and position information of the message; determining a message cluster to which the message belongs according to the position information of the message; and evaluating on address classifiers to identify the address of one message.

According to another aspect of the invention, a message processing system is provided, comprising: acquiring means configured to acquire messages and position information of the messages; clustering means configured to cluster the messages according to the position information of the messages, to obtain message clusters; extracting means configured to extract addresses in contents of the messages in the message cluster; and classification training means configured to obtain classifiers of the addresses based on the contents of the messages in the message cluster.

Related embodiments of the invention can conveniently provide the message users with related accurate address information by sufficiently utilizing the position information of the related message. Due to the feature of time sensitive, our invention can work as a basis for further address aware message management, mining and searching, and can formulate a series of commercial intelligent programs to provide useful information for management decision.

### BRIEF DESCRIPTION OF THE DRAWINGS

In order to describe the features and advantages of the embodiments of the invention in detail, the following accompanying drawings are made reference to. If possible, the same or like reference signs are used in the accompanying drawings and in the description to denote the same or like composite parts, wherein:

FIG. 1 shows a first embodiment of the message processing method of the invention;

FIG. 2 shows a second embodiment of the message processing method of the invention;

FIGS. 3 and 4 show a third embodiment of the message processing method of the invention;

FIG. 5 shows a fourth embodiment of the message processing method of the invention; and

FIG. 6 shows a block diagram of the message processing system of the invention.

### DETAILED DESCRIPTION

The exemplary embodiments of the invention will be described in detail below with reference to the accompanying drawings in which the same reference sign always denotes the same composite part. It should be understood that, the invention is not limited to the disclosed exemplary embodiments. It should be further understood that, not all the features of the method and apparatus are essential to carry out the invention as claimed in any of the claims. Furthermore, in the disclosure, when a process or method is displayed or described, the steps of the method may be executed in any order or simultaneously, unless it is obvious from the context that a step depends on another step previously executed. Furthermore, a distinct time space may exist between the steps.

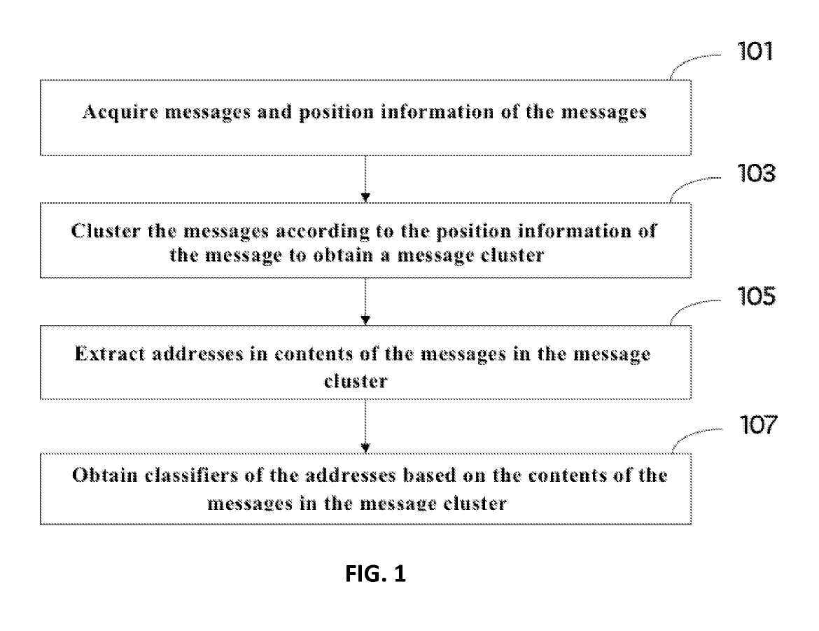

The first embodiment of the invention will be described in detail below with reference to FIG. 1. In a step 101, messages and position information of the messages is acquired, the messages can be microblog messages or messages in any other social network service supporting mobile terminals. It should be noted that, although the microblog message is taken as an example here, this does not mean that the invention is limited to such a kind of message. Such a kind of message includes a content body in which a content of the message is contained, for example, “I'm watching a movie in Megabox” is the specific content of the message. In addition, in general, position information of the message is transmitted along with the message, the position information being GPS coordinates. Other information transmitted along with the message also can be received, e.g., message transmission time, message reception time by the server, and the information received can be used in the embodiments of the invention. There are many approaches to acquire messages and position information of the messages, for example, voluntary, timing and in batch pushing by the message server, or automatically collecting messages from the message server using a network spider and updating the collected messages in time, or acquiring the message by directly deploying the method or system of the invention in the message server.

In a step 103, the messages are clustered according to the position information of the message to obtain message clusters. Messages can be clustered into different message clusters by using a distance-based clustering technology, e.g., K-Means algorithm, AP (Affinity Propagation) algorithm (for the K-Means algorithm, please specifically see the document: J. B. MacQueen (1967): “Some Methods for classification and Analysis of Multivariate Observations, Proceedings of 5-th Berkeley Symposium on Mathematical Statistics and Probability”, Berkeley, University of California Press, 1:281-297; for the AP algorithm, please specifically see the document: Clustering by Passing Messages Between Data Points. Brendan J. Frey and Delbert Dueck, University of Toronto Science 315, 972-976, February 2007). For example, by using a related clustering technology, it is found that there are a great number of messages within range of a zone with a certain radius from a GPS position; Of course, there are other ways to name a related message cluster, for example, a central GPS position or a unique sequence number. After obtaining the related message cluster and corresponding messages, various processing can be made, such as, storing the message cluster and the corresponding messages to a message database 109, or creating indexes for the message cluster and the corresponding messages, and etc. Indexes can be created by using various existing index creating methods, e.g., BaiDu, Google or other search engine indexing methods.

In a step 105, addresses in contents of the messages in each message cluster of are extracted. Here, address entity recognition techniques in natural language learning can be used, specifically, see Tjong Kim Sang, E. F. and De Meulder, F. 2003. Introduction to the CoNLL-2003 shared task: language-independent named entity recognition. In proceedings of the Seventh Conference on Natural Language Learning At HLT-NAACL 2003—Volume 4 (Edmonton, Canada). Human Language Technology Conference. Association for Computational Linguistics, Morristown, N.J., 142-147. For example, for such an unstructured natural language as a message “I'm watching a movie in Megabox cinema”, by using the entity recognition technique, it can be recognized that “Megabox cinema” is an address. Preferably, due to a difference in frequency that an address is mentioned by messages, it is considered to select the addresses in each cluster by occurrences. For example, if in the message cluster, an address is mentioned by only a few messages (e.g., 3 messages), it is considered to delete the address from the extracted address queue.

In a step 107, address classifiers are built based on the contents of the messages in the message cluster. If N addresses (where N is an integer greater than 1) are obtained from the step 105, by respectively using contents of the messages containing the N addresses mentioned in the message cluster as training samples, classifiers respectively corresponding to the N addresses can be obtained based on a Support Vector Machine model (specifically see Support Vector Machines and other kernel-based learning methods John Shawe-Taylor & Nello Cristianini—Cambridge University Press, 2000), a Maximal Entropy model (specifically see A maximum entropy approach to natural language processing AL Berger, VJD pietra, SAD pietra—Computational linguistics, 1996) or other existing learning models. After obtaining the classifiers respectively corresponding to the N addresses, various subsequent processing can be made, for example, storing the classifiers respectively corresponding to the N addresses, or creating indexes for the message cluster and the classifiers respectively corresponding to the N addresses. A simple example of obtaining classifiers of the addresses based on the contents of the messages in the message cluster is listed below: for example, there are four messages (merely for illustratively helping those skilled in the art to understand the present embodiment) in a message cluster as follows:

1. “I'm watching a movie in Megabox, while eating popcorn”;

2. “The movie is good and the popcorn is good too”;

3. “There is a sales promotion in Carrefour, ten yuan for 3 bottles of sour milk”;

4. “It is to my profit after the sales promotion of the sour milk”.

Through address entity extraction, both messages 1 and 3 contain address information: “Megabox” and “Carrefour”, so two classifiers can be constructed according to the two addresses using the information in the messages 1 and 3, and words such as “movie”, “popcorn”, “sour milk” and “sales promotion” can be selected as features to train the classifiers. If messages similar to the messages 2 and 4 contain such features, the message 2 may be classified into “Megabox” and the message 4 can be classified into “Carrefour” with a very high confidence. Associated address classifiers can be stored in a message database 109. These processing results are beneficial to the latter embodiments of the invention.

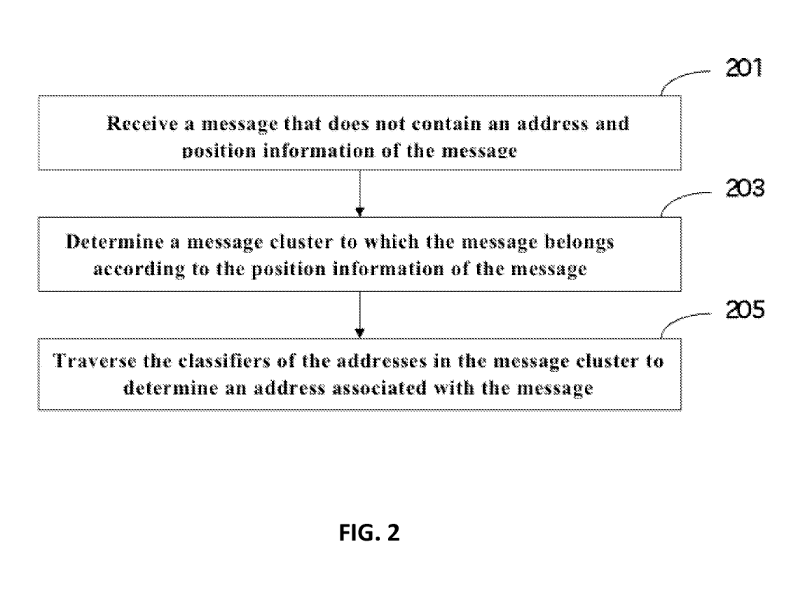

FIG. 2 shows the second embodiment of the invention. In a step 201, a message that does not contain an address and position information of the message is received. Sometimes a message user wants to find a special place in a zone but is not familiar with the surroundings or even cannot correctly input the name of the zone, specifically, for example, if the user wants to find out a cinema in great demand in the ZHONGGUANCUN zone, in this case, the user can transmit a message like “please recommend a cinema in great demand in the zone” to the message server. The message server receives the message that does not contain a specific address and position information at which the message is transmitted.

In a step 203, a message cluster to which the message belongs is determined according to the position information of the message, wherein the message cluster to which the message belongs is determined based on the message clusters which have stored in the database 109 in the former embodiments, using the position information of the message. The message cluster to which the message belongs can be determined by judging whether or not the position (e.g. GPS position) of the message falls into the zone range of the message cluster (e.g. GPS position range). For example, it is determined according to the position information of the message that the message user is in the ZHONGGUANCUN message cluster zone.

In a step 205, the classifiers of the addresses in the message cluster is traversed to determine an address associated with the message. Based on the content of the message, a confidence score of the message is calculated respectively using the classifiers of the addresses in the obtained message cluster, and an address corresponding to a classifier having a highest confidence score is selected and used as the address associated with the message. While using the classifier, the output result will have a quantized confidence score, for example, in order to judge whether or not a message is associated with an address, if a value 1 is returned, this represents completely associated, and if a value 0 is returned, this represents completely unassociated. For example, according to the content of the message “please recommend a cinema in great demand in the zone” inputted by the message user, by traversing the classifier “Megabox” and the classifier “Carrefour”, confidence scores of “Megabox” and “Carrefour” for the message illustratively are 0.95 and 0.15, respectively, and thus “Megabox” can be used as an address associated with the message of the message user and recommended to the message user. Preferably, a threshold for the confidence score may be set, and if the confidence scores obtained by traversing all the classifiers all are less than the threshold, a null address is returned, which shows that no associated address is associated with the message. Preferably, the information associated with the address is sent and presented to the user through classification and arrangement, and the user can further contact with the sender of the presented message to get timely suggestions from other persons.

Another preferable implementation of the above second embodiment can aim at any message whose content does not contain address information, for example, the message that has been stored in the message database 109 and does not contain an address, so only the steps 203 and 205 are executed, and preferably, indexes are created for the obtained associated address and the message.

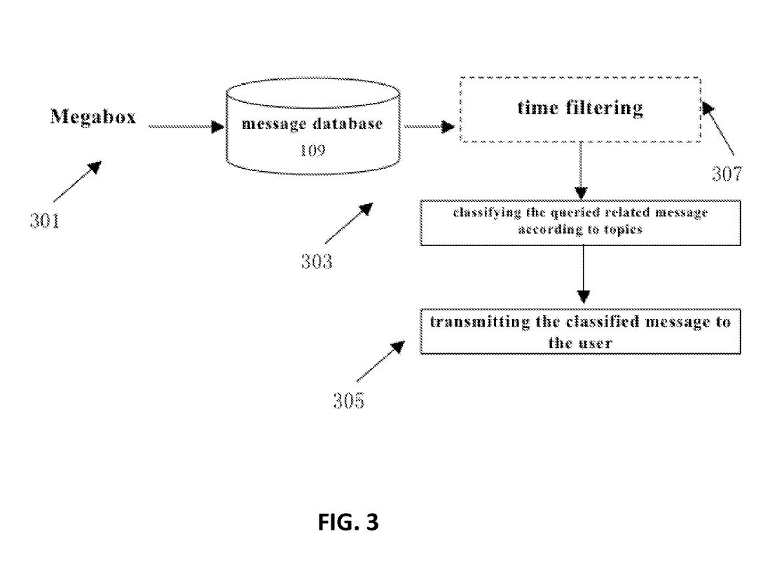

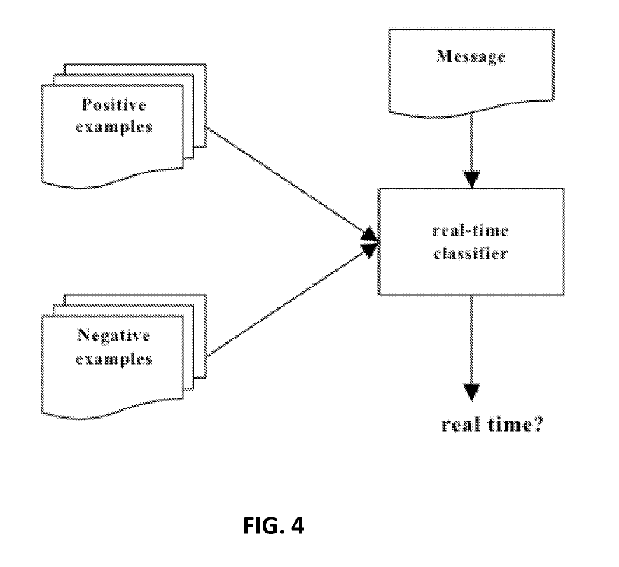

FIGS. 3 and 4 show the third embodiment of the invention. In a step 301, a query request containing an address from a message user is received. The query request requesting by a user can comprise a query about the associated address, for example, inputting a query “Megabox”. In a step 303, a message related to the address in the query request is queried and the queried message is classified according to topics. In the step, the message database 109 has been formed by the former embodiments, in which the message and an index of the associated address are stored, and in response to receipt of the user's query request containing the address, a message related to the address queried by the user is obtained according to related index retrieval, and the queried message is classified based on a K-means clustering algorithm, or topics model, e.g., a LDA model (specifically see Blei, David M.; Ng, Andrew Y.; Jordan, Michael I; Lafferty, John (January 2003). “Latent Dirichlet allocation”. Journal of Machine Learning Research 3: pp. 993-1022.

doi:10.1162/jmlr.2003.3.4-5.993.
http://jmlr.csail.mit.edu/papers/v3/blei03a.html).

In a step 305, the classified message is transmitted to the user. Preferably, it may comprise time-filtering the retrieved related message, as shown in a step 307 of Fig.3, thereby providing the user with the most timely message. Time-filtering includes two kinds of time-filtering. Transmission time filtering can be made on the retrieved related message from the beginning, for example, messages transmitted four hours before the user retrieval can be thrown away, according to the transmission time of the messages. However, although some messages are transmitted within four hours before the user retrieval, they discuss previous matters, for example, a message A reads as “I drank a cup of nice coffee in xxx cafe the day before yesterday . . . ”, so in order to push the message to the user in time, a message real-time filtering method is needed. FIG. 4 shows a message real-time filtering method of the invention, in which, by training based on the Support Vector Machine model, the Maximal Entropy model and etc. using a great number of positive examples (e.g., “I'm drinking coffee in xxx cafe”) and negative examples (e.g., “I drank coffee in xxx cafe a few days ago”), a real-time classifier is obtained. In training, firstly, texts in the positive examples and negative examples are divided into words, each as a feature to train the classifier. In the example, “-ing” and “a few days ago” both are distinguishing features, thereby obtaining a real-time classifier. After obtaining the real-time classifier, the message can be inputted to the real-time classifier to judge whether or not the message is in real time; for those messages that are not in real time, they can be thrown away and are not pushed to the user, thereby guaranteeing timeliness of the message.

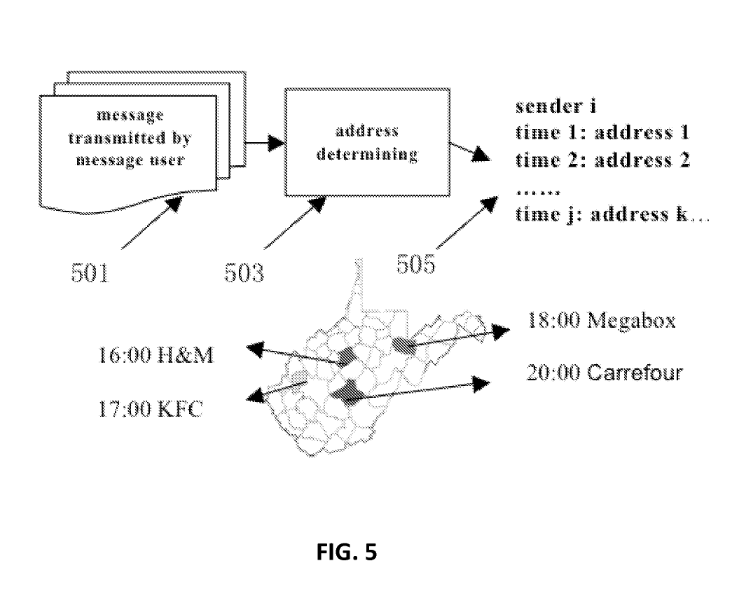

Due to timeliness and updating frequency of the message such as microblog message, one microblog can be viewed as a social sensor for providing immediate messages about the user and the surroundings thereof. The address of microblog issuance can be deduced according to the above embodiments of the invention, whereby the user's behaviors can be analyzed by synthesizing geographical address information to be provided to an analysis decision program. Based on the above principle, FIG. 5 shows the fourth embodiment of the invention. In a step 501, a message, a message related time and position information of the message is received. The message related time can be a message transmission time, or a message reception time by the message server, or other types of time stamp; in a step 503, according to the above embodiments, an address associated with the message is determined. In the step, if the message per se contains an address, the address can be extracted from the message as an address associated with the message, and if the message per se does not contain an address, the address can be predicted according to the method recited in the second embodiment of the invention. Preferably, time filtering may be made on the received message in pre-processing, thereby guaranteeing that the processed message is a thing about which the user is discussing that he/his is doing at the current address, thereby further guaranteeing timeliness of the address. In a step 505, indexes is created according to the message user, message related time and the associated address, in which an address contained in the message content is used as the address associated with the message. The message user can be characterized by a unique number of the mobile terminal, and the unique number of the mobile terminal can be, for example, a telephone number, a mobile terminal hardware sequence number, and etc. The indexes are shown in FIG. 5, comprising a message user i is at address k on time j, for example, the bottom of FIG. 5 shows that a message user is fitting in H&M on 16:00, eating at KFC on 17:00, watching a movie at Megabox on 18:00, and shopping at Carrefour on 20:00. Preferably, the indexes are associated with a specific message. Preferably, the obtained indexes are stored in the message database 109, thereby providing basic data for subsequent specific applications.

The fifth and sixth embodiments of the invention are discussed in detail below. In some hot spots, such as commercial centers and Transport hub, it may be important to learn density or migration situations of a stream of people at different addresses over time. By analyzing associations between the message related time and the associated addresses of a plurality of message users, the associated address or related information between the associated addresses are obtained, and related management is performed by using the related information.

The fifth embodiment of the invention may be used for learning density of the message users at different addresses, wherein a plurality of message users, the message related time and the associated address can be obtained, by retrieving the indexes that are stored in the message database 109 and created according to the message, message user, message related time and the associated address. On the basis of the above information obtained, a number of times that each message user appears at the associated address in a specified period of time can be respectively counted. For example, in a time period of 13:00-18:00, 1,000 message users in all appear at the address Megabox. In this way, for different addresses, different message user density degrees are obtained, and by comparing density degrees of different message users at different addresses with each other, different hot spot addresses can be determined. By finding out hot spot addresses, they can help the manager to manage related zones more effectively. For example, if a hot spot address is a merchant that is in great demand among the same kind of merchants within a business zone in a period of time, activities such as directed advertisement issuance may be made; if the hot spot address is a traffic hot spot in a period of time, the manager may consider road reforming, adding shunt or adding other security measures using the information, by using the information. In addition, the information can serve as network service contents to be pushed to the message users.

The sixth embodiment of the invention may be used for learning migration situations of the message users at different addresses, wherein the plurality of message users, the corresponding message related time, and the associated address are obtained through the indexes in the message database 109. By associating different addresses with different times of the same message user, a path of one message user in a period of time can be obtained, which is a time sequence data. By analyzing different message users, a plurality of paths with time information are obtained, from which a path in great demand in a specified period of time can be found. This can help the manager to manage the related zone more effectively. For example, if the hot spot path is an association path between merchants in great demand, the following commercial intellectual applications can be provided based on the path information: business zone planning, for planning a business zone according to a time sequence of the addresses went to by a number of users such that the user's walking time is the shortest; advertisement issuance, for finding a path that a great number of users most possibly pass by when going to a shop, on which a competitor can issue advertisements or open a shop; if the hot spot path is a traffic hot spot path, the manager can consider road reforming, adding shunt or adding other security measures, by using the information. In addition, the information can be considered as network service contents to be pushed to the message user.

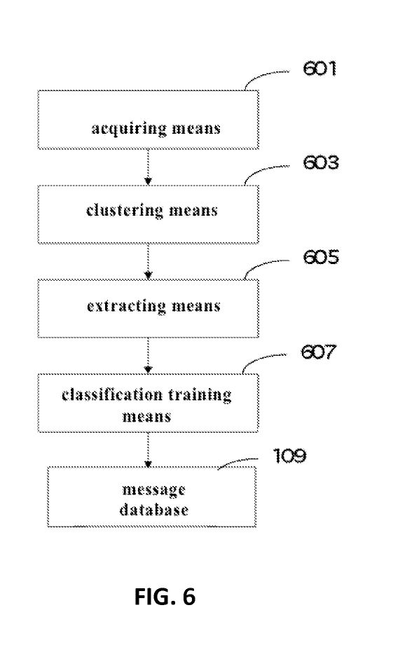

The seventh embodiment of the invention will be described in detail below in combination with FIG. 6. The seventh embodiment of the invention may be to provide a message processing system. The message processing system comprises acquiring means 601 configured to acquire a message and position information of the message; clustering means 603 configured to cluster the message according to the position information of the message to obtain a message cluster; extracting means 605 configured to extract an address in a content of the message in the message cluster; and classification training means 607 configured to obtain a classifier of the address based on the content of the message in the message cluster. Methods concerned in the related system and means have been explained in detail above and thus are omitted here. Preferably, the obtained message cluster and the classifier of the address are stored in the message database, and indexes are created for the message cluster, the address and the associated classifier and are stored in the message database 109.

Preferably, the extracting means 605 further comprises means configured to count the messages containing the extracted addresses; means configured to queue the extracted addresses according to the counts of the messages containing the addresses; and means configured to delete the addresses the count of which are less than a count threshold.

Preferably, the message processing system further comprises: means configured to receive a message that does not contain an address and position information of the message; means configured to determine a message cluster to which the message belongs according to the position information of the message; and means configured to traverse the classifiers of the addresses in the message cluster to determine an address associated with the message.

Preferably, the means configured to traverse the classifiers of the addresses in the message cluster to determine an address associated with the message comprises: means configured to determine an address having a highest confidence score obtained by the classifier of the address in the message cluster as the address associated with the message.

Preferably, the message processing system further comprises: means configured to create indexes according to the message and its associated address, wherein if the content of the message contains an address, the address is used as the address associated with the message.

Preferably, the message processing system further comprises: means configured to receive a query request containing an address from a message user; means configured to query a message related to the address in the query request and classify the queried message according to topics; and means configured to transmit the classified message to the user.

Preferably, the means configured to classify the queried message related to the address in the query request according to topics further comprises: means configured to filter the queried message in real time.

Preferably, the message processing system further comprises: means configured to create indexes according to the message user, the message related time and the associated address, wherein if the content of the message contains an address, the address is used as the address associated with the message.

Preferably, the message processing system further comprises: means configured to analyze associations between the message related time and the associated addresses of a plurality of message users, to obtain related information between the message user, the message related time and the associated addresses.

Preferably, the related information between the message user, the message related time and the associated addresses comprises at least one of the following: change in the number of the message users at the associated addresses over the message related time, and migration situations of the message users between the associated addresses over the message related time.

In addition, the message processing method according to the invention can be implemented by a computer program product that comprises a software code portion for implementing the simulation method of the invention when it is running in the computer.

The invention can be implemented by recording a computer program in a computer readable recording medium, the computer program comprising a software code portion for implementing the method of the invention when it is running in the computer. That is, a process of the method according to the invention can be distributed in a form of instructions in the computer readable medium or in other forms, regardless of a particular type of the signal carrier medium actually used for performing the distribution. The computer readable medium comprise a medium such as EPROM, ROM, magnetic tape, paper, floppy disk, hard disk drive, RAM and CD-ROM, and a transmission type medium such as digital and analog communication links.

Although the invention are exhibited and described with reference to the preferred embodiments of the invention, those skilled in the art would appreciate that, various amendments to formality and details can be made without departing from the spirit and scope of the invention as defined by the attached claims.

What is claimed is:

1. A message processing method, comprising:
acquiring messages and position information of the messages;
clustering the messages according to the position information of the messages to obtain a message cluster;
extracting addresses in a content of the messages in the message cluster; and
obtaining classifiers of the addresses based on the content of the messages in the message cluster.

2. The method according to claim 1, wherein extracting addresses in a content of the message in the message cluster further comprises:
counting the messages containing the extracted addresses;
queuing the extracted addresses according to counts of the messages containing the addresses; and
deleting addresses the counting of which are less than a count threshold.

3. The method according to claim 1, further comprising:
for a message the content of which does not contain an address, determining a message cluster to which the message belongs according to position information of the message; and
traversing the classifiers of the addresses in the message cluster to determine an address associated with the message.

4. The method according to claim 3, wherein traversing the classifiers of the addresses in the message cluster to determine the address associated with the message comprises:
determining an address having a highest confidence score obtained by a classifier of the address in the message cluster as the address associated with the message.

5. The method according to claim 3, further comprising:
creating indexes according to the message and its associated address, wherein if the content of the message contains an address, the address is used as the address associated with the message.

6. The method according to claim 5, further comprising:
receiving a query request containing an address from a message user;
querying a message related to the address in the query request and classifying the queried message according to topics; and
transmitting the classified message to the message user.

7. The method according to claim 6, wherein classifying the queried message according to topics further comprises:
filtering the queried message in real time.

8. The method according to claim 3, further comprising:
creating indexes according to a message user, a message related time and the associated address, wherein if the content of the message contains an address, the address is used as the address associated with the message.

9. The method according to clam 8, further comprising:
analyzing associations between the message related time and associated addresses of a plurality of message users, to obtain related information between the message user, the message related time and the associated addresses.

10. The method according to claim 9, wherein the related information between the message user, the message related time and the associated addresses comprises at least one of the following:
change in a number of the message users at the associated addresses over the message related time; and
migration situations of the message users between the associated addresses over the message related time.

11. The method according to claim 1, wherein the position information comprises one of GPS coordinates and a microblog service API.

12. The method according to claim 1, wherein the message is a microblog message.

13. A message processing system comprising:
acquiring means configured to acquire messages and position information of the messages;
clustering means configured to cluster the messages according to the position information of the messages to obtain a message cluster;
extracting means configured to extract addresses in a content of the messages in the message cluster; and
classification training means configured to obtain classifiers of the addresses based on the content of the messages in the message cluster.

14. The system according to claim 13, wherein the extracting means further comprises:
means configured to count the messages containing the extracted addresses;
means configured to queue the extracted addresses according to counts of the messages containing the addresses; and
means configured to delete addresses the count of which are less than a count threshold.

15. The system according to claim 13, further comprising:
means configured to, for a message that does not contain an address, determine a message cluster to which the message belongs according to position information of the message; and
means configured to traverse the classifiers of the addresses in the message cluster to determine an address associated with the message.

16. The system according to claim 15, wherein the means configured to traverse the classifiers of the addresses in the message cluster to determine the address associated with the message comprises:
means configured to determine an address having a highest confidence score obtained by the classifier of the address in the message cluster as the address associated with the message.

17. The system according to any of claims 15, further comprising:
means configured to create indexes according to the message and its associated address, wherein if the content of the message contains an address, the address is used as the address associated with the message.

18. The system according to claim 17, further comprising:
means configured to receive a query request containing an address from a message user;
means configured to query a message related to the address in the query request and classify the queried message according to topics; and
means configured to transmit the classified message to the user.

19. The system according to claim 18, wherein the means configured to query the message related to the address in the query request and classify the queried message according to topics further comprises: means configured to filter the queried message in real time.

20. The system according to claim 15, further comprising:
means configured to create indexes according to a message user, a message related time and the associated address, wherein if the content of the message contains an address, the address is used as the address associated with the message.

21. The system according to claim 20, further comprising:
means configured to analyze associations between the message related time and associated addresses of a plurality of message users, to obtain related information between the message user, the message related time and the associated addresses.

22. The system according to claim 21, wherein the related information between the message user, the message related time and the associated addresses comprises at least one of the following:
change in a number of the message users at the associated addresses over the message related time; and
migration situations of the message users between the associated addresses over the message related time.
